(19) United States
(12) Patent Application Publication
(10) Pub. No.: US 2004/0188263 A1
(43) Pub. Date: Sep. 30, 2004

(54) Copper foil with carrier foil, process for producing the same and copper clad laminate including the copper foil with carrier foil

(76) Inventors: Akiko Sugimoto, Ageo-shi (JP); Junshi Yoshioka, Ageo-shi (JP); Makoto Dobashi, Ageo-shi (JP); Kenjirou Izutani, Ageo-shi (JP); Youzo Itagaki, Ageo-shi (JP); Osamu Nakano, Ageo-shi (JP)

Correspondence Address: ROTHWELL, FIGG, ERNST & MANBECK, P.C., 1425 K STREET, N.W., SUITE 800, WASHINGTON, DC, 20005, US

(21) Appl. No.: 10/480,298

(22) PCT Filed: Apr. 11, 2003
(86) PCT No.: PCT/JP03/04612

(30) Foreign Application Priority Data
Apr. 12, 2002 (JP) 2002-110532
Dec. 4, 2002 (JP) 2002-352060

(51) Int. Cl. B32B 15/08

(52) U.S. Cl. 205/111; 428/626; 428/612; 428/935; 148/518

(57) ABSTRACT

The object is to provide carrier foil-incorporated copper foil which permits drilling by a carbon dioxide laser when on the surface of outer-layer copper foil of a copper-clad laminate there is no nickel assist metal layer or an organic material film to increase the absorption of laser light. For this purpose, there is used, for example, carrier foil-incorporated copper foil in which copper foil for printed wiring board manufacturing having a nodular-treated surface on the side of one surface of a bulk copper layer and carrier foil are laminated via an adhesive interface layer on a side opposite to the nodular-treated surface of the bulk copper layer, the bulk copper layer being formed from a high-carbon copper with a carbon content of 0.03 wt % to 0.40 wt %.

### TECHNICAL FIELD

The present invention related to carrier foil-incorporated copper foil. More particularly, the present invention relates to copper foil which is useful when drilling such as via hole drilling by a carbon dioxide laser is performed.

### BACKGROUND ART

In recent years, due to requirements for miniaturized design of electronic and electric equipment, the downsizing of printed wiring boards mounted in such equipment has been simultaneously carried out and the wiring circuit density, packaging density and multi-layer design of printed wiring boards have become remarkable. The multi-layer design of printed wiring boards refers to a state in which multiple layers forming a conductor circuit are formed via an insulating resin layer, and it is general practice to provide interlayer connection means such as what is called a through hole, a via hole, etc. as interlayer connection means between layers forming a conductor circuit.

Among the interlayer connection means, “a through hole” is formed by mechanically drilling a printed wiring board and interlayer connection is ensured by plating the inner wall of this through hole with copper. In contrast, “a via hole” includes a through hole, a blind via hole which is not a through hole and is in the state of a concavity, and an interstitial via hole which is embedded in the interior of a layer of a printed wiring board. However, the common feature of “a via hole” resides in that the hole diameter is very small compared to “a through hole” and that mechanical drilling is difficult.

Therefore, in forming the configuration of a via hole, the laser drilling method has been adopted in consideration of the advantages that fine holes can be drilled, that drilling position accuracy is excellent and that the drilling speed is high. Although various laser oscillation sources are used in laser drilling, what is called a carbon dioxide laser is in the widest use.

However, when a copper foil layer and an insulating resin layer of a printed wiring board are to be simultaneously drilled by use of a carbon dioxide laser, it has been difficult to accomplish good drilling due to the existence of the copper foil layer. In order to solve this problem, a technique has begun to be used which involves increasing the absorption efficiency of laser light by using copper foil which has on its surface a nickel layer or a nickel alloy layer as an assist metal layer (hereinafter simply refereed to as “a nickel assist metal layer”) thereby improving the drillability by a carbon dioxide laser. On the other hand, a method of forming an organic material film capable of increasing the absorption efficiency of laser light on the surface of copper foil has also begun to be widely used.

In a case where a nickel assist metal layer or an organic material film is provided on the surface of copper foil, after the completion of drilling as shown in FIG. 9(a), the nickel assist metal layer or the organic material film is removed as shown in FIG. 9(b). After that, a plated copper layer to obtain interlayer connection is formed on the inner surface wall of a via hole by performing copper plating treatment and etching for circuit formation is performed.

The above-described contents are suggested in the Japanese Patent No. 3258308, the Japanese Patent Publication No. 2001-347599, etc.

In the prior art, however, problems as described above arose. In a case where a nickel assist metal layer is provided, because it is necessary to remove the nickel assist metal layer by etching after laser drilling, nickel components are eluted in a waste etching liquid or a cleaning water and waste liquid treatment becomes complicated, causing an increase in the manufacturing cost and running cost of printed wiring boards. On the other hand, also in a case where an organic material film is provided, because the removal of the organic material film is required after laser drilling, organic material film components are contained in a waste etching liquid or a cleaning water and waste liquid treatment becomes complicated, causing an increase in the manufacturing cost and running cost of printed wiring boards.

Also, when the nickel assist metal layer is to be removed by etching, with the exception of a case where a nickel selective etching liquid is used in order to cause only nickel to be dissolved in the coexistence of nickel or a nickel alloy and copper and thereby to prevent the dissolution of copper components, in an etching liquid ordinarily used in nickel removal, the dissolution rate of nickel is low and the etching liquid corrodes even the copper components constituting a circuit, with the result that pinholes are generated within the circuit and that the circuit is dissolved and lost. If the above-described nickel selective etching liquid is used, this results in an increase in the production cost because the liquid is a special etching liquid.

In view of the foregoing, it follows that copper foil which permits drilling by a carbon dioxide laser is required ideally in the absence of a nickel assist metal layer and an organic material film.

### DISCLOSURE OF THE INVENTION

Hence, the present inventors devoted themselves to conducting research and as a result hit upon copper foil which permits direct drilling by a carbon dioxide laser, as described below, without providing a dissimilar metal such as a nickel assist metal layer and an organic material film which increase the laser absorption efficiency.

Carrier foil-incorporated copper foil (1): According to a claim, there is provided carrier foil-incorporated-copper foil in which copper foil for printed wiring board manufacturing having a nodular-treated surface on the side of one surface of a bulk copper layer and carrier foil are laminated via an adhesive interface layer on a side opposite to the nodular-treated surface of the bulk copper layer, characterized in that the bulk copper layer is formed from a high-carbon copper having a carbon content of 0.03 wt % to 0.40 wt %. A schematic sectional view of this copper foil is shown in FIG. 1.

Metal foil, such as aluminum foil and copper foil, organic films having electrical conductivity, etc. can be used as the carrier foil C. Electrical conductivity is required by the manufacturing method, which is described below. The thickness of this carrier foil C is not especially limited. However, the bulk copper layer 2 can be made very thin due to the presence of the carrier foil C, and the carrier foil C is very useful when the thickness of the bulk copper layer 2 is not more than 9 μm.

According to the type of the adhesive interface layer B provided on the surface of this carrier foil C, the adhesive interface layer is divided into an etchable one which requires that the carrier foil of the carrier foil-incorporated copper foil be removed by etching and a peelable one which enables this carrier foil to be removed by peeling. In the case of the present invention, the adhesive interface layer is described as a concept which includes the two.

In the case of an etchable one, the carrier foil-incorporated copper foil is manufactured, for example, by precipitating metal components of the adhesive interface layer, such as zinc, in somewhat small amounts and thereafter forming the bulk copper layer on the adhesive interface layer. In contrast, in a peelable one, the carrier foil-incorporated copper foil is manufactured by forming metal oxides represented by zinc, chromium and chromate, etc. as a thick layer when a metal material is used in the adhesive interface layer or by using an organic agent.

In particular, in a peelable one, it is desirable that the adhesive interface layer be formed by using an organic agent. This is because the peeling strength in peeling the carrier foil can be stabilized at a low level. The organic solvent used here is concretely as follows.

An organic agent constituted by one kind or two or more kinds of organic agents selected from nitrogen-containing organic compounds, sulfur-containing organic compounds and carboxylic acid is used. The nitrogen-containing organic compounds include nitrogen-containing organic compounds having a substituent. Concretely, it is desirable to use 1,2, 3-benzotriazole (hereinafter referred to as “BTA”), carboxybenzotriazole (hereinafter referred to as “CBTA”), N′, N′-bis (benzotriazolemethyl) urea (hereinafter referred to as “BTD-U”), 1H-1, 2, 4-triazole (hereinafter referred to as “TA”) and 3-amino-1H-1, 2, 4-triazole (hereinafter referred to as “ATA”), etc. as nitrogen-containing organic compounds.

It is desirable to use mercaptobenzothiazole (hereinafter referred to as “MBT”), thiocyanuric acid (hereinafter referred to as “TCA”), 2-benzimidazolethiol (hereinafter referred to as “BIT”), etc. as sulfur-containing organic compounds.

It is desirable to use monocarboxylic acid, in particular, as carboxylic acid and among others, it is desirable to use oleic acid, linolic acid, linolenic acid, etc.

In forming the adhesive interface layer using these organic agents, it is possible to adopt [1] a method which involves immersing the carrier foil in a solution containing an organic agent, [2] a method which involves showering or dropping a solution containing an organic agent onto a surface of the carrier foil, [3] a method which involves electrodepositing an organic agent to the carrier foil, etc. However, in the case of the immersion method of [1], an adhesive interface layer is formed on both surfaces of the carrier foil. Therefore, it might be thought that this is contradictory to “an adhesive interface layer is formed on a one-side surface of the carrier foil . . . ” of a manufacturing method described in a claim. However, the inventors make it clear that this sentence of the claim means that “an adhesive interface layer is formed at least on a one-side surface of the carrier foil . . . ”.

By providing the bulk copper layer on the above-described adhesive interface layer and providing the roughened layer on the bulk copper layer, the carrier foil-incorporated copper foil related to the present invention is obtained. In this carrier foil-incorporated copper foil, by sticking the nodular-treated surface to a substrate such as a prepreg, with the carrier foil kept incorporated, and by removing the carrier foil thereafter, the state of an ordinary copper-clad laminate is obtained. After the removal of the carrier foil, the bulk copper layer constituted by a high-carbon copper is exposed as the top surface layer and laser drilling is performed in this state.

At the present stage, a clear theory as to why laser drillability is easily improved by using a high-carbon copper layer as the bulk copper layer has not yet been established. However, during the continuation of the research the present inventors have gained the impression that laser drillability may be improved by the following theory.

The copper which constitutes the bulk copper layer of conventional copper foil is what is called pure copper having a purity of not less than 99.99 wt % and the carbon content of this copper is 0.005 wt % or so. In contrast, the bulk copper layer of the copper foil in the present invention is constituted by a high-carbon copper with a carbon content of 0.03 wt % to 0.40 wt %. In this manner, the thermal conductivity of copper is reduced by raising the carbon content of the copper. Pure copper, which has a thermal conductivity of 354 W·m⁻¹·K⁻¹ at 700° C., is a good conductor of heat. However, the thermal conductivity of the high-carbon copper related to the invention having a carbon content of 0.03 wt % to 0.40 wt % because of the presence of organic matter becomes about 100 to 180 W·m⁻¹·K⁻¹. Thus, the thermal conductivity decreases.

The present inventors considered the reason why laser drilling is difficult with usual copper foil as follows. If the laser output energy is denoted by P and the surface reflection and thermal conduction loss by η, then the energy which contributes to an increase in the temperature of a workpiece is P (1−η). Therefore, the relationship P (1−η)=m·C·ΔT holds. If the diameter of a hole drilled by laser light is denoted by d, the drilled thickness by H and the specific weight of copper by ρ, then the value of m at this time is π(d/2)²·H·ρ and P (1−η)=π(d/2)²·H·ρ·C·ΔT. Hence, ΔT=4P (1−η)/(π(d²·H·ρ·C). The conditions under which copper is melted are considered using this equation. Here, under the assumption that the pulse width is 18 μsec., that the pulse energy is 16.0 mJ, that the laser light diameter is 160 μm, and that a hole with a drilled diameter of 125 μm is formed in copper foil having various thicknesses. Furthermore, under the assumption that ρ=8.94 g/cm³ and that C=0.39 J/K·g, the above-described reason is considered using ΔT=4P (1−η)/(10.95·d²·H) as a theoretical equation.

In order to permit the drilling of the copper foil by laser light, the laser light must melt copper and bring the copper to a temperature of not less than the melting point. When a temperature rise is simulated by using the reflectance on the surface of the molten copper foil as the value of η on the basis of the above theoretical equation, it follows that a difference of not less than 1,000° C. in a temperature rise is produced by a change of only 1% in reflectance, and it becomes apparent that in order to permit continuous melting of the copper foil layer, it is necessary to satisfy the condition that the reflectance be less than 98%.

Although the initial surface of the copper foil which is the object of laser drilling is a surface having a luster, it has roughness to a certain degree and cannot be said to be a smooth mirror surface. However, when the irradiation with laser light is started, the copper foil surface having a prescribed roughness begins to melt and the copper components of the initially irradiated surface is melted and vaporizes. Then, under the initially irradiated surface is formed a copper surface which is a smooth mirror surface. The reflectance of the copper surface which has become a mirror surface usually becomes not less than 98%. As a result, laser drilling at a depth deeper than a certain level becomes difficult.

When copper is to be drilled by a laser, a process in which the copper vaporizes continuously for a thickness of the prescribed copper foil must be reproduced. That is, during laser irradiation, the temperature of at least the irradiated part must exceed the boiling temperature of copper.

However, a comparison of thermal conductivity is made here between pure copper and a high-carbon copper. Pure copper is a good conductor of heat whose thermal conductivity is 354 W·m⁻¹·K⁻¹ at 700° C. In contrast, the thermal conductivity of a high-carbon copper is 100 to 180 W·m⁻¹·K⁻¹ at 700° C., which is about ⅓ to ½ of the thermal conductivity of pure copper. Thus, it is apparent that the thermal conductivity of a high-carbon copper is very low compared to that of pure copper. In view of the fact, when the copper foil surface having a bulk copper layer constituted by the pure copper of a copper-clad laminate is irradiated with laser light, part of the laser light is reflected from the copper foil surface of the mirror surface and the remaining laser light is, as heat energy, applied to a prescribed position which forms a through hole or a hole portion, such as an interstitial via hole or a blind via hole. At this time, as the copper foil surface becomes melted and changes in quality to a mirror surface state, the reflectance of laser light increases and the ratio of conversion to heat energy decreases accordingly. In terms of the area of a whole copper-clad laminate, the area of the portion laser drilled is very narrow and, therefore, even when the temperature of this portion reaches a high temperature instantaneously, copper which is a good conductor of heat immediately diffuses the quantity of heat given by laser light. Hence, it might be thought that it becomes difficult for the quantity of heat which has concentrated to stay in a portion. That is, it might be thought that the rate at which the quantity of heat given to the copper foil diffuses and disperses. become higher than the supply rate of heat energy given by laser light, and that it becomes difficult for copper to reach its boiling point.

In contrast, a high-carbon copper conducts heat at a rate which is as low as about ½ to ⅓ of the thermal conductivity of pure copper. Therefore, when the surface of the copper foil having the bulk copper layer constituted by the high-carbon copper of a copper-clad laminate is irradiated with laser beam, the supply rate of heat energy by laser light is higher than the diffusion rate of heat and the heat energy is concentrated on the irradiated portion. Hence, it might be thought that the temperature of the laser irradiated portion easily reaches' the boiling point of copper. And it might be thought that the heat energy which has been transmitted to the copper foil having the bulk copper layer constituted by this high-carbon copper is less apt to be dissipated because of the low overall thermal conductivity of the bulk copper layer and that a temperature rise easily exceeding the melting temperature of copper occurs continuously in addition to the supply of heat energy by the continuous irradiation with laser light, with the result that the removal of the copper foil layer by laser light is performed easily.

Table 1 shows the results of a laser drilling test conducted on a double-sided copper-clad laminate, which was fabricated by sticking the above-described carrier foil-incorporated copper foil with a nominal thickness of the copper coil layer of 3 μm to both surfaces of a 200 μm thick FR-4 prepreg by press working. Incidentally, this laser drilling test was carried out by 1-shot drilling by using pulse energy of 16.0 mJ (total machining energy: 20 mJ). For other laser irradiation conditions, the frequency was 2,000 Hz, the mask diameter was 5.5 mm, the pulse width was 2 μsec., the offset was 0.0, and the laser light diameter was 120 μm. In the test, an attempt was made to make 400 holes each having a diameter of 100 μm in the copper-clad laminate. Therefore, the present inventors judged that the drilling was performed satisfactorily when the hole diameter after drilling became 90 to 110 μm.

TABLE 1

| | Carbon content of high- | Results of evaluation of laser |
|---|---|---|
| Sample No. | carbon copper (wt %) | drillability* 16 mJ |
| 1 | 0.003 | 5 |
| 2 | 0.015 | 115 |
| 3 | 0.030 | 400 |
| 4 | 0.080 | 400 |
| 5 | 0.102 | 400 |
| 6 | 0.244 | 400 |
| 7 | 0.317 | 400 |
| 8 | 0.385 | 400 |

*Results of evaluation of laser drillability

The results show the number of good holes obtained when 400 holes were drilled by using drilling energy of 16 mJ.

As is apparent from this table, a comparison is made between a copper-clad laminate using ordinary copper foil with a nominal thickness of 6 μm in which the bulk copper layer is formed from only a pure copper layer with a carbon content of 0.003 wt % (Sample No. 1 in the table) and a copper-clad laminate having a 2 μm thick high-carbon copper layer with a carbon content of 0.015 wt % to 0.40 wt % and a 3 μm thick pure copper layer as an outer layer (Sample Nos. 2 to 8 in the table). From the comparison of the laser drillability of these samples, it might be thought that laser drillability is remarkably improved when the carbon content of the high-carbon copper layer exceeds 0.08 wt %. That is, all of the 400 holes were satisfactorily drilled. Therefore, the carbon content of the high-carbon copper layer has a lower limit of 0.08 wt %. The reason why an upper limit of 0.40 wt % is set will be described in connection with the manufacturing method below. It is very difficult to cause carbon to be contained in an amount exceeding this carbon content.

Carrier foil-incorporated foil (2): On the other hand, in the case of copper foil in which the whole of the above-described bulk copper layer is constituted by a high-carbon copper, the thermal conductivity decreases compared to pure copper and it might be thought that the electrical resistance value increases. And it can be supposed that disadvantages resulting from the low thermal conductivity and the high electrical resistance value occur. That is, in some circuit design, the places where the carrier foil-incorporated foil can be used may be limited. In particular, even when there is no problem at the present stage, the heat generation problem in high frequency applications, delays in signal transmission, etc. might be caused because the clock frequency of computers has been increasing at a GHz level.

Therefore, it becomes possible to solve the above problem by using “carrier foil-incorporated copper foil in which copper foil for printed wiring board manufacturing having a nodular-treated surface on the side of one surface of a bulk copper layer and carrier foil are laminated via an adhesive interface layer on a side opposite to the nodular-treated surface of the bulk copper layer, characterized in that the bulk copper layer has a high-carbon copper layer with a carbon content of 0.08 wt % to 0.40 wt % and a thickness of 0.1 μm to 5 μm on a side opposite to the nodular-treated surface and a pure copper layer under the high-carbon copper layer” described in another claim. This carrier foil-incorporated copper foil is schematically shown in FIG. 2.

That is, in this carrier foil-incorporated copper foil 1′, only a 0.1 μm to 5 μm thick portion on a side opposite to a nodular-treated surface 4 of a bulk copper layer 2 in contact with an adhesive interface layer B is formed from a high-carbon copper layer 5 and other portion of the bulk copper layer is formed from a pure copper layer 6. By adopting this layer construction, the high-carbon copper layer 5 is left behind after the removal of the carrier foil C until laser drilling is completed in the state of the copper-clad laminate and only the high-carbon copper layer 5 is removed in the stage of the surface conditioning stage of the surface of the copper-clad laminate prior to the subsequent plating process. That is, only the high-carbon copper layer 5 can be easily removed by using chemical etching treatment or physical treatment, such as buffing treatment, or by a combination of these treatments. If this high-carbon copper layer 5 can be removed, only the pure copper layer 6 remains on the copper-clad laminate and it follows that materials which might provide inhibitory factors of the electrical resistance of a finally formed conducting circuit do not exist.

Now a laser machining theory when a high-carbon copper layer of a predetermined thickness is provided on a copper foil surface is considered. For heat conduction performance, the thermal conductivity of pure copper is 354 W·m⁻¹·K⁻¹ at 700° C. and the thermal conductivity of a high-carbon copper is 100 to 180 W·m⁻¹·K⁻¹ at 700° C. Thus, the thermal conductivity of a high-carbon copper is about ⅓ to ½ of the thermal conductivity of pure copper and the heat conduction performance of a high-carbon copper is very low compared to pure copper. Therefore, when the surface of a high-carbon copper layer formed on the copper foil of a copper-clad laminate is irradiated with laser light, the heat energy is concentrated only on the irradiated portion of the high-carbon copper and the supply rate of heat energy by laser light is higher than the diffusion rate of heat. Hence, it might be thought that the temperature of the laser irradiated potion easily reaches the melting point of the high-carbon copper.

As a result, it might be thought that in the high-carbon copper a temperature rise due to irradiation with laser light occurs rapidly compared to pure copper, with the result that the high-carbon copper melts easily and evaporates. And it might be thought that when once the high-carbon copper begins to melt due to the irradiation with laser light and its temperature reaches the melting point, the quantity of heat of the boiling temperature of the high-carbon copper is transmitted to the pure copper layer, which is a good conductor, and that the heat energy transmitted to this pure copper layer is less apt to be dissipated partly because the copper foil surface is coated with the high-carbon copper having low thermal conductivity, with the result that a temperature rise easily exceeding the melting temperature of copper occurs continuously in addition to the supply of heat energy by the continuous irradiation with laser light and that the removal of the copper foil layer by laser light is performed easily.

Table 2 shows the results of a laser drilling test conducted on a double-sided copper-clad laminate, which was fabricated by sticking the above-described carrier foil-incorporated copper foil formed from a high-carbon copper layer (about 3 μm) and a pure copper layer (about 6 μm) with a nominal thickness of the copper coil layer of 9 μm to both surfaces of a 200 μm thick FR-4 prepreg by press working. Incidentally, the laser drilling test was carried out under the same test conditions as used in Table 1.

TABLE 2

| | Carbon content of high- | Results of evaluation of laser |
|---|---|---|
| Sample No. | carbon copper (wt %)* | drillability** 16 mJ |
| 1 | 0.003 | 4 |
| 2 | 0.017 | 52 |
| 3 | 0.032 | 167 |
| 4 | 0.081 | 400 |
| 5 | 0.125 | 400 |
| 6 | 0.256 | 400 |
| 7 | 0.339 | 400 |
| 8 | 0.394 | 400 |

*Copper foil for printed wiring boards in which the bulk copper layer is formed only by pure copper is used only in Sample No. 1. In other samples, copper foil for printed wiring boards with a nominal thickness of 9 μm in which an about 3 μm thick high-carbon copper layer and an about 6 μm thick pure copper layer are laminated is used.
**Results of evaluation of laser drillability

The results show the number of good holes obtained when 400 holes were drilled by using drilling energy of 16 mJ.

As is apparent from this table, a comparison is made between a copper-clad laminate using ordinary copper foil in which the bulk copper layer is formed from only a pure copper layer with a carbon content of 0.003 wt % and a copper-clad laminate using copper clad which is constituted by a high-carbon copper layer with a carbon content of 0.015 wt % to 0.40 wt % (about 3 μm) and a pure copper layer (about 6 μm). From the comparison of the laser drillability of these samples, it might be thought that the laser drillability is remarkably improved when the carbon content of the high-carbon copper layer exceeds 0.08 wt %. That is, all of the 400 holes were satisfactorily drilled. Therefore, the carbon content of the high-carbon copper layer has a lower limit of 0.08 wt %. The reason why an upper limit of 0.40 wt % is set will be described in connection with the manufacturing method below. It is very difficult to cause carbon to be contained in an amount exceeding this carbon content.

It is preferred that the thickness of the high-carbon layer be 0.1 to 5 μm. This range was determined as a range in which the removal of the high-carbon copper layer after laser drilling is easy and it is possible to sufficiently exercise the role of improving the laser drillability of the high-carbon copper layer, which is described below. This is because even when a high-carbon copper layer with a thickness exceeding the upper limit of 5 μm is formed, laser drillability will not further increase and this only makes the removal work after laser drilling difficult and impairs economical efficiency.

When the thickness is less than the lower limit of 0.1 μm, variations occur in laser drillability. For example, even in the case of a thickness of 0.03 μm, laser drillability will be improved compared to a case where a copper-clad laminate having no high-carbon copper layer is used. Although by far superior laser drillability is obtained, variations among lots increase. Incidentally, whether the surface of the high-carbon copper layer formed here may be a smooth metal surface having a luster or a matt surface, there is no hindrance at all. This case fundamentally differs from a case where a lustrous copper foil surface is directly drilled in this point.

By using the above-described two types of carrier foil-incorporated copper foil in the manufacturing of a copper-clad laminate, the direct laser drilling of the copper layer of the copper-clad laminate can be easily performed without providing a dissimilar metal layer, such as a nickel assist metal layer, or an organic material layer etc. to increase the absorption efficiency of laser light etc.

It has been described that the high-carbon copper layer shows excellent laser drillability whether copper foil for printed wiring boards is in “the case where the high-carbon copper layer is used as the bulk copper layer” and “the case where the high-carbon copper layer is used only for the surface layer portion of the bulk copper layer” described above. However, during further research it became apparent that even when the carbon content of the high-carbon copper layer is the same, laser drillability differs depending on a difference in the crystal-structure.

The crystal structures of a high-carbon copper layer produced by electrodeposition can be divided into the following two types. That is, Type [1] is “an acicular structure which has grown almost linearly from a deposition start position DS to a deposition finish position DF and, at the same time, a fine crystal structure as shown in FIG. 3” and Type [2] is “a crystal structure which has grown discontinuously from a deposition start position DS to a deposition finish position DF although this seems to be very fine crystal structure as shown in FIG. 4.” Either of the structures enables laser drillability to be improved compared to a case where a high concentration of carbide is not contained. However, out of these crystal structures, the case of Type [1] of a continuously grown acicular structure and a fine crystal structure shows the best laser drillability.

A clear difference in laser drillability between Type [1] and Type [2] becomes apparent from the results of laser drilling. This low-energy laser drilling test was carried out using pulse energy of 8.3 mJ for the first shot and pulse energy of 1.7 mJ for the second shot (total machining energy: 10 mJ). For other laser irradiation conditions, the frequency was 2,000 Hz, the mask diameter was 7.0 mm, the pulse width was 21 μsec. for the first shot and 2 μsec. for the second shot, the offset was 0.0, and the laser light diameter was 140 μm. In the test, an attempt was made to make 400 holes each having a diameter of 100 μm in the copper-clad laminate. As a result, the opening ratio was 100% with 400 holes/400 holes in the case of the copper foil having the crystal structure of Type [1] with a nominal thickness of 9 μm, whereas the opening ratio was 0% with 0 hole/400 holes in the case of the copper foil having the crystal structure of Type [2] with a nominal thickness of 9 μm.

It might be thought that the level of the fineness of the acicular structure of Type [1] can be easily grasped from a comparison with the crystal structure of the electrodposited copper foil on the pure copper side of FIG. 3. This pure copper layer was provided to make a comparison between the crystal structure of the high-carbon copper used in the present invention and a usual electrodeposited copper foil structure. It will be understood that the width of the crystal grain of the acicular structure of Type [1] is very small compared to the crystal structure of this pure copper layer. A crystal structure of this shape is very useful in laser drilling. The present inventors consider that in terms of a grain size level, thermal conduction is faster within grains than at grain boundaries. Therefore, it might be thought that compared to an acicular crystal structure which has grown discontinuously, in an acicular crystal structure in which the shape of grains grows continuously, heat is easily conducted longitudinally along the shape of grains, facilitating the drilling in the thickness direction of the copper foil.

Method of manufacturing carrier foil-incorporated copper foil (1): Subsequently, a method of manufacturing the above-described carrier foil-incorporated copper foil will be described. First, a claim describes “a method of manufacturing the carrier foil-incorporated copper foil, which involves forming an adhesive interface layer on a surface of the carrier foil forming a bulk copper layer on the adhesive interface layer, subjecting. the bulk copper layer to nodular treatment and further subjecting the bulk layer to required surface treatment, characterized in that the bulk layer is fabricated by electrolysis of a copper electrolyte containing one kind or two or more kinds selected from glue, gelatin and collagen peptide in an amount of 30 ppm to 1,000 ppm. This manufacturing method relates to carrier foil-incorporated copper foil in which the whole of the bulk copper layer is formed from a high-carbon copper.

In a method of manufacturing a carrier foil-incorporated copper foil related to the present invention, carrier foil is used as the starting material and an adhesive interface layer is formed on a surface of this carrier foil. A bulk copper layer is formed on the adhesive interface layer and this bulk copper layer is subjected to nodular treatment. And after that, further required surface treatment is performed.

In the present invention, a method which involves directly depositing the bulk copper layer on the adhesive interface layer by the electrolysis method by cathode polarizing the carrier foil formed on which the adhesive interface layer has been formed in a copper electrolyte is adopted in the formation of the bulk copper layer. The manufacturing method related to the invention is characterized by the copper electrolyte used in the formation of this bulk layer. Also in the bulk copper layer of usual carrier foil-incorporated foil, there is adopted a technique in which glue is added in a level of not more than 10 ppm to a copper sulfate solution in order to improve the elongation rate of the electrolytic copper foil etc. In contrast, in the manufacturing method related to the invention, a concentration range of not less than 30 ppm of glue etc. is adopted. By adopting a concentration range of not less than 30 ppm, it can be ensured that the carbon content of the high-carbon copper is not less than 0.03 wt %.

An investigation was made into the relationship between the glue concentration of a copper sulfate solution, which is a copper electrolyte, and the carbon content of the high-carbon copper obtained by the electrolysis of this copper sulfate solution. The result of the investigation is shown in FIG. 5. As is apparent from FIG. 5, it is apparent that a logarithmic functional relationship holds if the carbon content of the high-carbon copper is taken as ordinate and the glue concentration of the copper sulfate solution used in the manufacturing as abscissa. That is, at a glue concentration of the copper sulfate solution of about 1,000 ppm the carbon content becomes 0.40 wt % and almost reaches a saturated state, with the result that the carbon content of the high-carbon copper will not increase any more. As shown in the results demonstrated in the laser drilling test, laser drillability begins to increase dramatically at a glue concentration of the copper sulfate solution in excess of 30 ppm or more. This tendency applies also to a case where gelatin or collagen peptide is used.

In a crystal structure of a high-carbon copper layer manufactured by electrodeposition, it is possible to appropriately make either of the above-described Type [1] and Type [2] by controlling current density. Strictly speaking, it is difficult to clear current values because there is also a relation to the concentrations of glue etc. of an electrolyte. For example, a low current density of not more than 10 A/dm₂ is adopted when the crystal structure of Type [1] is to be obtained and a high current density of not less than 20 A/dm² is adopted when the crystal structure of Type [2] is to be obtained. Therefore, a current density should be determined for each process in consideration of the features of the production line, the concentrations of the components of the electrolyte, etc. when these types of crystal structure are to be appropriately made.

Method of manufacturing carrier foil-incorporated copper foil (2): Another claim describes “a method of manufacturing the carrier foil-incorporated copper foil, which involves forming an adhesive interface layer on a surface of the carrier foil, forming a bulk copper layer on the adhesive interface layer, subjecting the bulk copper layer to nodular treatment and further subjecting the bulk layer to required surface treatment, characterized in that a high-carbon copper layer with a thickness of 0.1 μm to 5 μm is formed by the electrolysis method by use of a copper electrolyte containing one kind or two or more kinds selected from glue, gelatin and collagen peptide in an amount of 100 ppm to 1,000 ppm and a pure copper layer is formed on the high-carbon copper layer by electrolysis of the copper electrolyte.” This manufacturing method relates to carrier foil-incorporated copper foil in which only a 0.1 μm to 5 μm thick portion on one side of the bulk copper layer in contact with the adhesive interface layer is the high-carbon copper layer, the other part is the pure copper layer and the other side is subjected to nodular treatment etc.

In the manufacturing of this carrier foil-incorporated copper foil, the adhesive interface layer on a surface of the carrier foil is first formed and the high-carbon copper layer is formed on this adhesive interface layer. By use of a copper electrolyte containing one kind or two or more kinds selected from glue, gelatin and collagen peptide in an amount of 100 ppm to 1,000 ppm, this high-carbon copper layer with a thickness of 0.1 μm to 5 μm is formed on the adhesive interface layer by the above-described electrolysis method.

Then, the pure copper layer is formed on the high-carbon copper layer. In this case, the pure copper layer forming the bulk copper layer is deposited by the electrolysis of a copper electrolyte used in the manufacturing of usual electrolytic copper foil. The copper electrolyte used at this time does not mean a completely pure copper sulfate solution etc. and the use of an additive used in the manufacturing of the conventional copper foil in a common-sense range is supposed. Therefore, this claim describes that it is naturally possible to add not more than 20 ppm of glue and to use other additives such as cellulose.

In the formation of the high-carbon copper layer at this time, a concentration range of not more than 100 ppm of glue etc. is adopted. By adopting a concentration range of 100 ppm, it can be ensured that the carbon content of the high-carbon copper is 0.08 wt %. The upper limit to the concentration is determined for the same reason as described above.

A carrier foil-incorporated copper foil related to the present invention can be obtained as described above. A copper-clad laminate obtained by using this copper foil for printed wiring boards enables the copper layer foil to be directly laser drilled without the need to provide a nickel assist metal layer or an organic material layer.

A copper-clad laminate manufactured by using the above-described carrier foil-incorporated copper foil prevents the copper foil surface on which a circuit is to be formed from damage and contamination in the state before the removal of the carrier foil owing to the presence of the carrier foil in the outer layer, and the copper foil surface from which the carrier foil has been removed can improve the drillability of a via hole etc. by use of a carbon dioxide layer.

### BRIEF DESCRIPTION OF THE DRAWINGS

FIGS. 1 and 2 are each a schematic sectional view of carrier foil-incorporated copper foil. FIGS. 3 and 4 are each an observational image of a sectional crystal structure of a high-carbon copper layer. FIG. 5 shows the relationship between the glue content of a copper sulfate solution and the carbon content of a high-carbon copper obtained by the electrolysis of this copper sulfate solution. FIGS. 6 and 8 are each a schematic drawing of the procedure for manufacturing carrier foil-incorporated copper foil. FIGS. 7 and 9 are each a schematic drawing of the procedure for laser drilling. In each of the above drawings, descriptions are given by using common numerals as far as possible. The numerals 1 and 1′ denote carrier foil-incorporated copper foil, the numeral 2 a bulk copper layer, the numeral 3 a fine copper grain which is used in nodular treatment, the numeral 4 a nodular-treated surface, the numeral 5 a high-carbon copper layer, the numeral 6 a pure copper layer, the character C carrier foil, the character B an adhesive interface layer, the character IB an inner-layer core material, the character IC an inner-layer circuit, and the character CL an inner-layer circuit-incorporated copper-clad laminate.

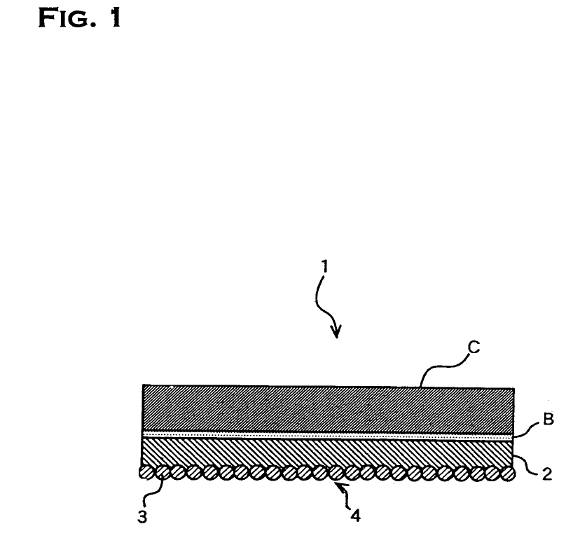

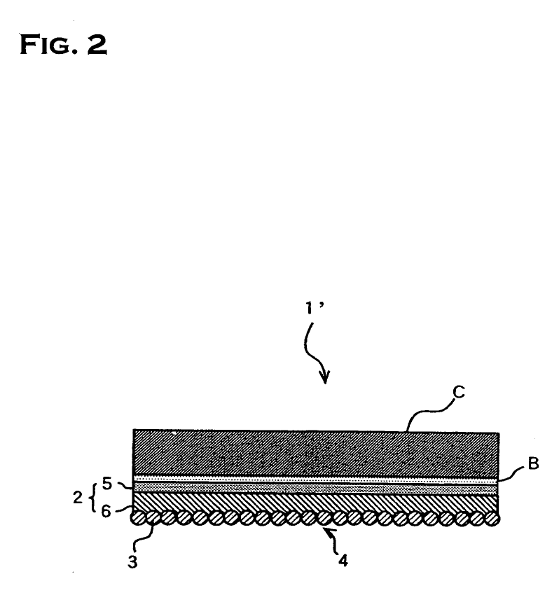

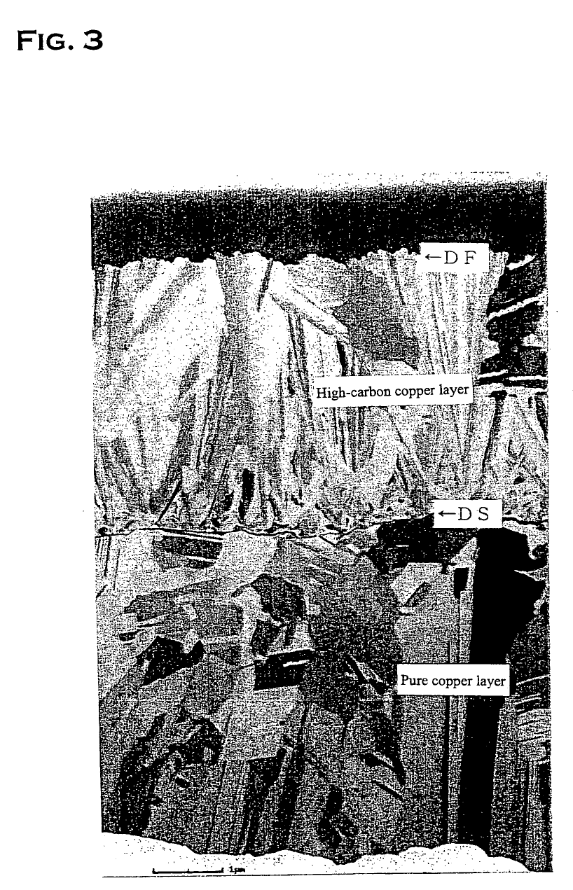

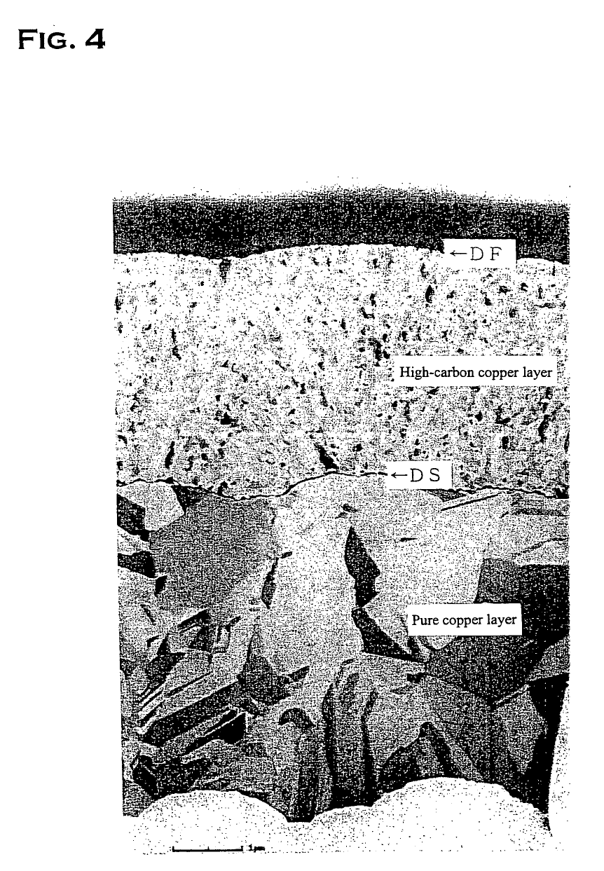

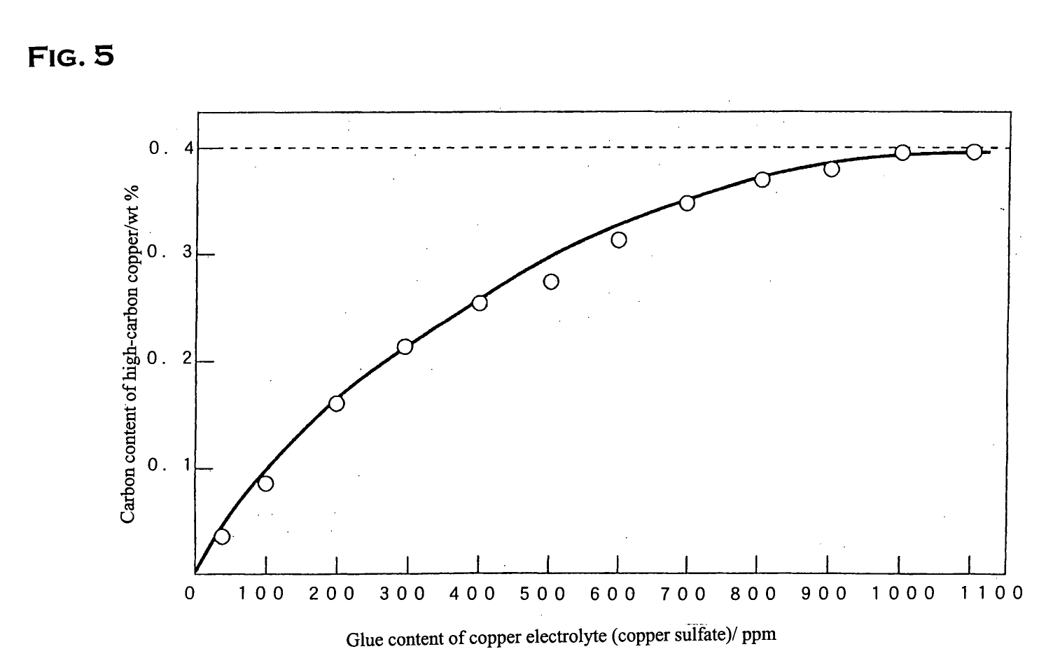

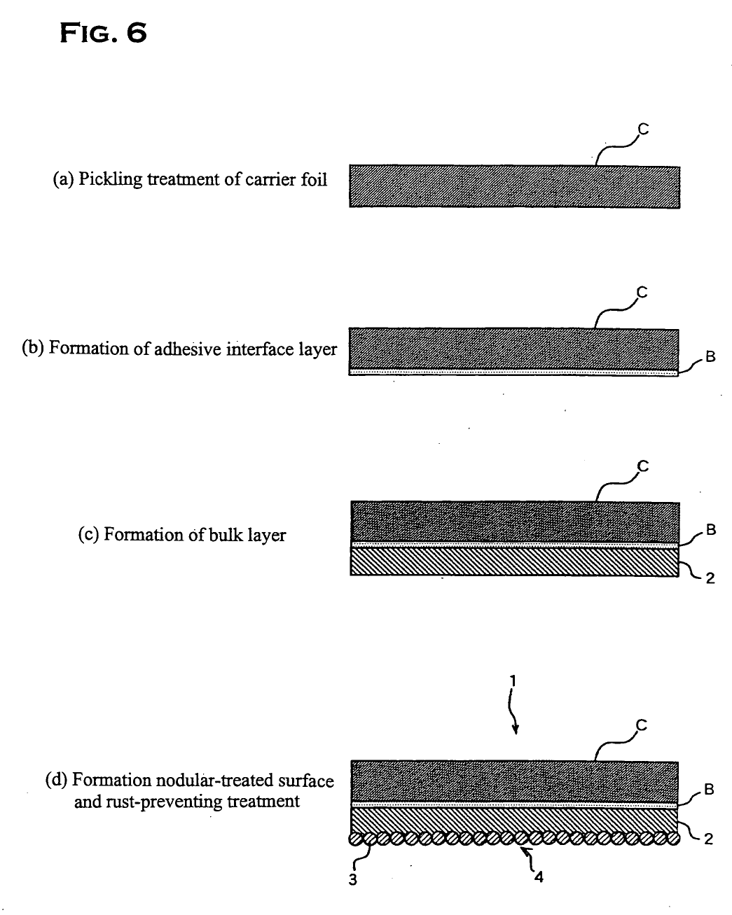

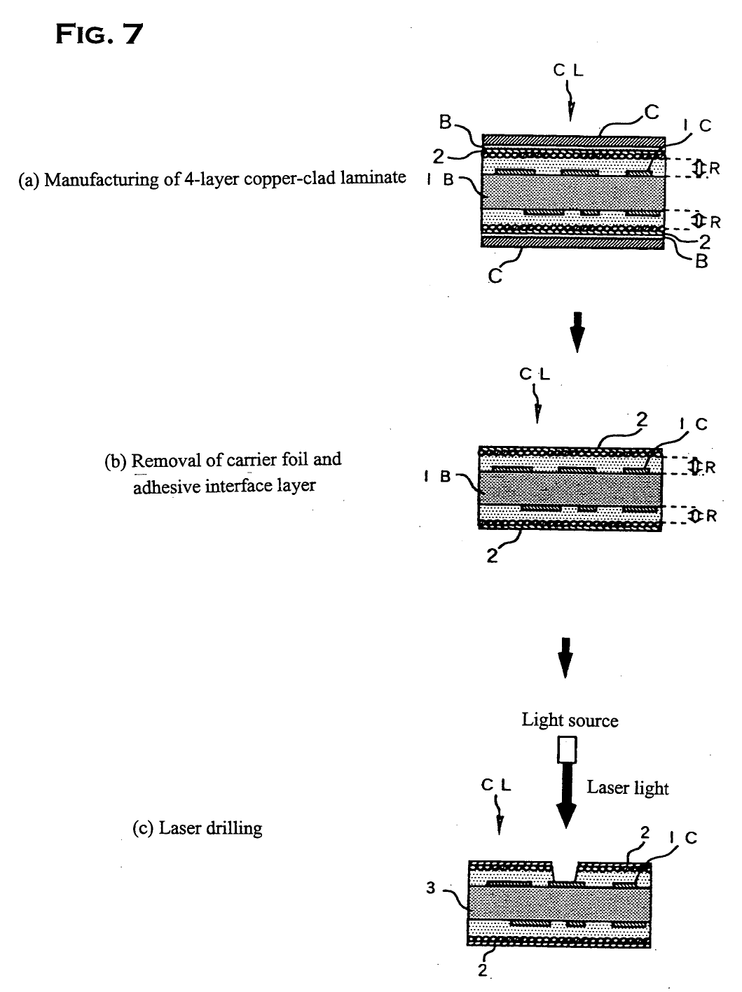

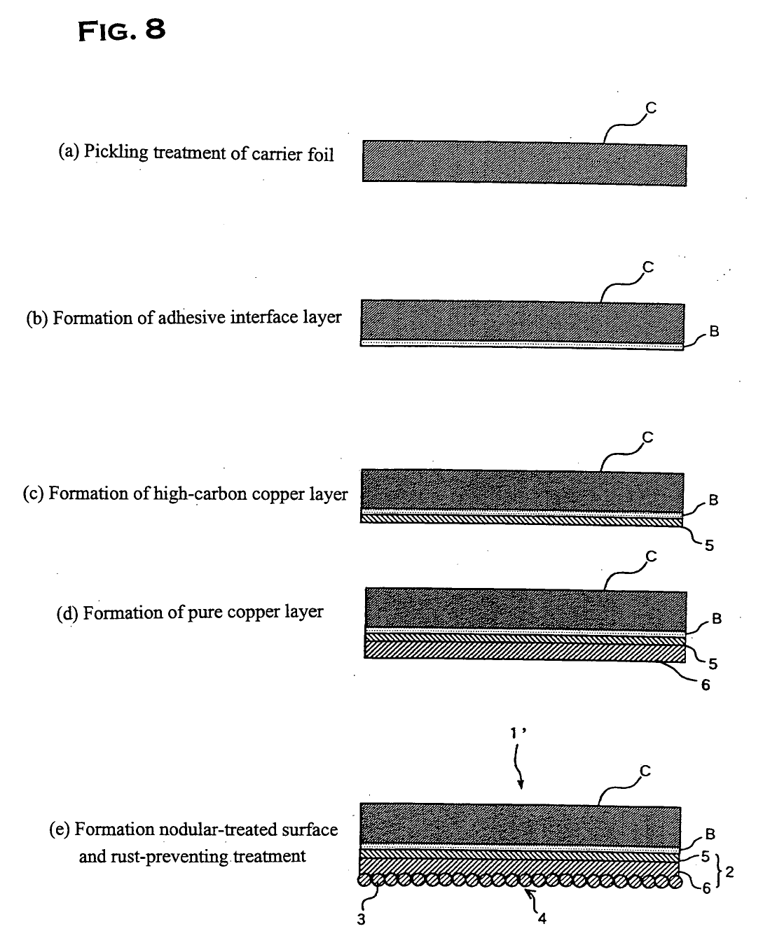

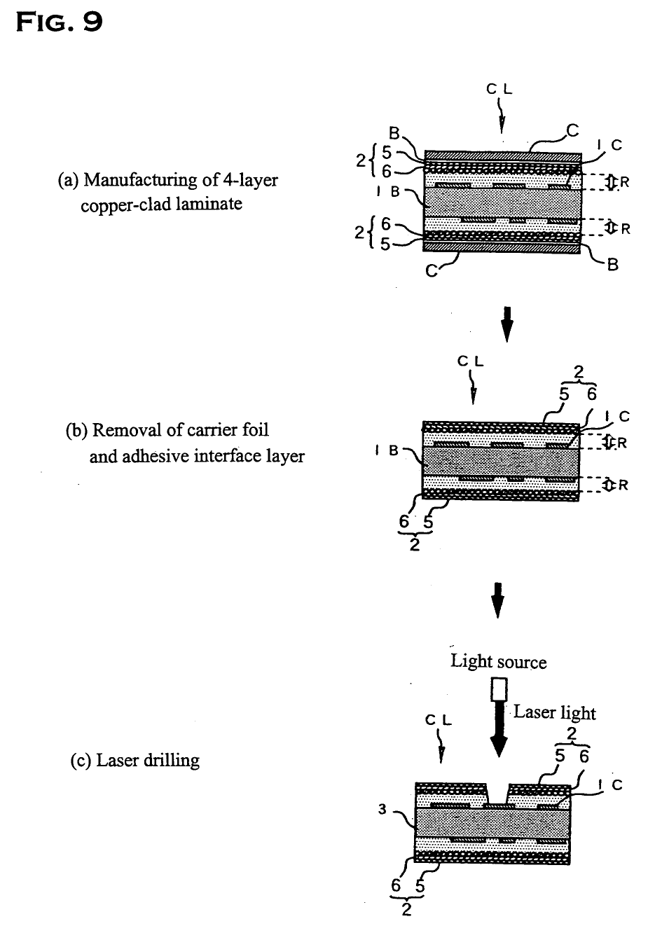

### BEST MODE FOR CARRYING OUT THE INVENTION

A copper-clad laminate was fabricated by use of the above-described carrier foil-incorporated copper foil, the carrier foil was removed from the copper-clad laminate, and laser drilling was performed. The results are described below.

### First Embodiment

In this embodiment, a carrier foil-incorporated copper foil 1 in which the whole of a bulk copper layer 2 is formed from a high-carbon copper was fabricated by the procedure shown in FIG. 6. In the step shown in FIG. 6 (a), first, 18 μm copper foil was used as carrier foil C and the surface of the carrier foil C was pickled, whereby adhering oil and fat components were completely removed and the removal of a redundant surface oxide film was performed. This pickling treatment was performed by using a diluted sulfiric acid solution of a concentration of 100 g/l and at a liquid temperature of 30° C. The immersion time was 30 seconds.

The carrier foil C for which pickling treatment had been completed was immersed for 30 seconds in an aqueous solution of pH 5, which contains CBTA with a concentration of 5 g/l, at a liquid temperature of 40° C., and an adhesive interface layer was formed on the surface, as shown in FIG. 6 (b). Strictly speaking, the adhesive interface layer B is formed on both surfaces of the carrier foil C. In the figure, however, only the adhesive interface layer B is formed on one surface side.

After the completion of the formation of the adhesive interface layer B, the carrier foil C itself on which the adhesive interface layer B had been formed was cathode polarized in a copper electrolyte and, as shown in FIG. 6 (c), a bulk copper layer 2 formed from a high-carbon copper (a balk copper layer to become a copper foil layer with a nominal thickness of 3 μm) was electrolytically deposited on this adhesive interface layer B. A copper sulfate solution was used as the electrolyte this time. The electrolysis was carried out at a current density of 5 A/dm² using this solution with a copper concentration of 55 g/l, a free sulfuric acid concentration of 70 g/l and a glue concentration of 800 ppm and at a liquid temperature of 40° C. Incidentally, the carbon content of this bulk copper layer 2 formed from a high-carbon copper was 0.35 wt % and the high-carbon copper layer had a crystal structure of Type [1].

As surface treatment, a nodular-treated surface 4 was formed by causing fine copper particles 3 to adhere to this bulk copper layer 2 by deposition. In the formation of this nodular-treated surface 4, as the step of forming the fine copper particles 3 on the bulk copper layer 3, the step of deposition of the fine copper particles 3 and the step of covering coating to prevent the falling-off of the fine copper particles 3 were carried out. In the former step of deposition of the fine copper particles 3, electrolysis was carried out at a current density of 10 A/dM² for 10 seconds in a sulfide copper solution with a copper concentration of 7 g/l and a sulfuric acid concentration of 100 g/l and at a liquid temperature of 25° C.

As described above, when once the fine copper particles 3 were deposited on the bulk copper layer 2, in the covering plating step to prevent the falling-off of the fine copper particles 3, copper was uniformly deposited so as to cover the fine copper particles 3 under smooth plating conditions in order to prevent the falling-off of the deposited fine copper particles 3. For the smooth plating conditions, electrolysis was carried out for 20 seconds in a copper sulfate solution with a copper concentration of 60 g/l and a sulfuric acid concentration of 150 g/l and a liquid temperature of 45° C. at a current density of 15 A/dm².

After the completion of the above-described nodular treatment, rust-preventing treatment was then carried out. The rust-preventing treatment was for preventing the oxidation and corrosion of the surfaces of the electrolytic copper foil layer and carrier foil. Although there is no problem if either of organic rust prevention which uses benzotriazole, imidazole, etc. inorganic rust prevention which uses zinc, chromate, zinc alloys, etc. is adopted, the inorganic rust prevention under the conditions described below was adopted here. Zinc rust prevention was carried out at a current density of 15 A/dM² in a zinc sulfate bath with a sulfuric acid concentration of 70 g/l and a zinc concentration of 20 g/l and at a liquid temperature of 40° C.

After the completion of the rust-preventing treatment, drying was finally performed for 40 seconds in a furnace heated to an atmosphere temperature of 110° C. by an electric heater, with the result that the carrier foil-incorporated foil 1 in which 3 μm thick copper foil is laminated via the adhesive interface layer B formed on the 18 μm thick carrier foil C using an organic agent is obtained. In the above process, a water washing step was provided between the steps to perform washing and the solutions of the preceding steps were prevented from being carried over.

By forming a resin layer on the nodular-treated surface 4 of this carrier foil-incorporated copper foil 1, the carrier foil-incorporated copper foil was brought to the state of what is called resin-incorporated copper foil. As shown in FIG. 7 (a), a copper-clad laminate incorporating an inner-layer circuit IC was fabricated from an inner-layer core material IB in which an inner-layer circuit is formed. That is, resin layers of this carrier foil-incorporated copper foil on which a resin layer is each formed were oppositely disposed on both surfaces of this inner-layer core material IB, and the carrier foil-incorporated copper foil and the inner-layer core material IB were bonded together by hot press working, whereby a copper-clad laminate incorporating an inner-layer circuit CL was fabricated. After that, as shown in FIG. 7 (b), the bulk copper layer 2 was exposed by simultaneously stripping the carrier foil C and adhesive interface layer B, which are positioned in the outer layers, by manual work.

And as shown in FIG. 7 (c), a hole portion which becomes a blind via hole was formed by directly irradiating the bulk copper layer with carbon dioxide laser light from this surface. The conditions shown in Table 1 above (total machining energy: 20 mJ) were adopted without a modification in the drilling by a carbon dioxide laser at this time. As a result, all drilled 400 holes were satisfactorily drilled. The out-of-roundness of the drilled holes was 0.95 on average. Furthermore, the drilling of 400 holes was performed under the above-described total machining energy of 10 mJ. As a result, all the 400 holes could be drilled although the out-of-roundness of the drilled holes was 0.92.

### Second Embodiment

In this embodiment, carrier foil-incorporated copper foil 1′ in which a bulk copper layer 2 is formed from a 3 μm thick high-carbon copper layer 5 and a 3μm thick pure copper layer 6 was fabricated by the procedure shown in FIG. 8. As the carrier foil C used here, 18 μm thick copper foil similar to that used in the first embodiment was used. The pickling treatment of a surface of the carrier foil C and the formation of an adhesive interface layer B after the completion of the pickling treatment were the same as in the first embodiment. Because the nodular treatment and rust-preventing treatment after the formation of the bulk copper layer 2 were also the same as in the first embodiment, their descriptions are omitted here to avoid overlaps in descriptions. Only the formation of the bulk copper layer 2 is described in detail.

After the completion of the formation of the adhesive interface layer B, the carrier foil C itself on which the adhesive interface layer B had been formed was cathode polarized in a copper electrolyte and the 3 μm thick high-carbon copper layer 5 and the 3 μm thick pure copper layer 6 on this adhesive interface layer B were sequentially formed. First, the high-carbon copper layer 5 which was to be in direct contact with the adhesive interface layer B was electrolytically deposited. A copper sulfate solution was used as the electrolyte this time. Electrodeposition was carried out by electrolysis at a current density of 5 A/dm² using this solution with a copper concentration of 55 g/l, a free sulfuiric acid concentration of 70 g/l and a glue concentration of 1,000 ppm and at a liquid temperature of 40° C. Incidentally, the carbon content of this high-carbon copper layer 5 was 0.40 wt % and the high-carbon copper layer had a crystal structure of Type [1].

Next, the 3 μm thick pure copper layer 6 was formed on the high-carbon copper layer 5 by performing electrolysis at a current density of 5 A/dm² in a copper electrolysis which was a copper sulfate solution with a copper concentration of 55 g/l, a free sulfuric acid concentration of 70 g/l and a glue concentration of 10 ppm and at a liquid temperature of 40° C.

As shown in FIG. 9, a 60 μm thick resin layer was formed on a nodular-treated surface 4 of the carrier foil-incorporated copper foil 1′ obtained by this manufacturing method in the same manner as in the first embodiment, and a copper-clad laminate incorporating an inner layer CL was fabricated from an inner-layer core material IB, in which an inner-layer circuit is formed, by the same method as in the first embodiment. By simultaneously stripping and removing the carrier foil C and the adhesive interface layer B by manual work, a hole portion which becomes a blind via hole was formed from the surface of this copper-clad laminate incorporating an inner-layer circuit CL by using a carbon dioxide laser. The conditions shown in Table 1 above were adopted without a modification in the drilling by a carbon dioxide laser at this time(total machining energy: 20 mJ). As a result, all drilled 400 holes were satisfactorily drilled. The out-of-roundness of the drilled holes was 0.94 on average. Furthermore, the drilling of 400 holes was performed under the above-described total machining energy of 10 mJ. As a result, all the 400 holes could be drilled although the out-of-roundness of the drilled holes was 0.89.

### Comparative Example

In this example, carrier foil-incorporated copper foil in which the whole of the bulk copper layer of the first embodiment was formed from pure copper was fabricated. The electrolyte used in the formation of the bulk copper layer at that time was a copper sulfate solution. In this solution with a copper concentration of 55 g/l, a free sulfuric acid concentration of 70 g/l and a glue concentration of 10 ppm and at a liquid temperature of 40° C. electrolysis was performed at a current density of 5 A/dm² and a 3 μm thick bulk copper layer was deposited on a surface on which an adhesive interface layer of carrier foil had been formed. Incidentally, the carbon content of this bulk copper layer was 0.01 wt %.

Because the nodular treatment and rust-preventing treatment etc. after the formation of the bulk copper layer were the same as in the first embodiment, their descriptions are omitted here to avoid overlaps in descriptions. In this manner, carrier foil-incorporated copper layer in which the whole of the bulk copper layer is formed from pure copper was fabricated.

From the carrier foil-incorporated copper layer obtained by this manufacturing method and an inner-layer core material in which an inner-layer circuit is formed, a copper-clad laminate incorporating an inner-layer circuit was fabricated by the same method as in the first embodiment. By stripping and removing the carrier foil by manual work, hole portions which become blind via holes were formed from both surfaces of this copper-clad laminate incorporating an inner-layer circuit by using a carbon dioxide laser. The conditions shown in Table 1 above were adopted without a modification as the conditions for the drilling by a carbon dioxide laser at this time.

After the completion of the laser drilling, all 400 holes obtained by the drilling were observed. As a result, only 5 out of the 400 holes were judged to have been satisfactorily drilled and the out-off-roundness of the holes which were judged to have been satisfactorily drilled was 0.90 on average. As is apparent from a comparison of this result with the above-described embodiments, it can be said that as the effect of the present invention, laser drillability is remarkably improved.

Furthermore, 400 holed were drilled under the condition of the total machining energy of 10 mJ in place of the above-described conditions. As a result, none of the 400 holes could be drilled. This makes clear that the laser drilling performance is completely different from the above-described embodiments.

### Industrial Applicability

As described above, by using carrier foil-incorporated copper foil related to the present invention, it becomes possible to directly drill holes in a copper-clad laminate by use of a carbon dioxide laser. Therefore, a nickel assist metal layer or an organic material layer which were required by all means on a surface of copper foil in order to increase the laser light absorption efficiency in the direct drilling of conventional copper foil have become unnecessary and the stripping step of the nickel assist metal layer etc. has become unnecessary because dissimilar metal elements etc. are not contained. Furthermore, the burden of waste water treatment is remarkably reduced. Therefore, a remarkable reduction of the total manufacturing cost becomes possible.

1. Carrier foil-incorporated copper foil in which copper foil for printed wiring board manufacturing having a nodular-treated surface on the side of one surface of a bulk copper layer and carrier foil are laminated via an adhesive interface layer on a side opposite to the nodular-treated surface of the bulk copper layer, characterized in that the bulk copper layer is formed from a high-carbon copper having a carbon content of 0.03 wt % to 0.40 wt %.

2. The carrier foil-incorporated copper foil according to claim 1, characterized in that a crystal structure of the bulk copper layer observed by a cross-section observation is a fine and continuous acicular crystal.

3. The carrier foil-incorporated copper foil according to claim 1 or 2, characterized in that the adhesive interface layer is an organic adhesive interface surface which is formed by use of one kind or two or more kinds of organic agents selected from nitrogen-containing organic compounds, sulfur-containing organic compounds and carboxylic acid, and said adhesive interface layer is peelable, thereby enabling the carrier foil to be removed by peeling.

4. Carrier foil-incorporated copper foil for use in copper foil for a printed wiring board in which copper foil with a carrier foil having a nodular-treated surface on the side of one surface of a bulk copper layer and carrier foil are laminated via an adhesive interface layer on a side opposite to the nodular-treated surface of the bulk copper layer, characterized in that the bulk copper layer has a high-carbon copper layer with a carbon content of 0.08 wt % to 0.40 wt % and a thickness of 0.1 μm to 5 μm on a side opposite to the nodular-treated surface and a pure copper layer under the high-carbon copper layer.

5. The carrier foil-incorporated copper foil according to claim 4, characterized in that a crystal structure of the high-carbon copper layer obtained by a cross-section observation is a fine and continuous acicular crystal.

6. The carrier foil-incorporated copper foil according to claim 4 or 5, characterized in that the adhesive interface layer is an organic adhesive interface which is formed by use of one kind or two or more kinds of organic agents selected from nitrogen-containing organic compounds, sulfur-containing organic compounds and carboxylic acid and the adhesive interface layer is peelable, thereby enabling the carrier foil to be removed by peeling.

7. A method of manufacturing carrier foil-incorporated copper foil according to any one of claims 1 to 3 claim 1, which involves forming an adhesive interface layer on a surface of the carrier foil, subjecting the bulk copper layer to nodular treatment and further subjecting the bulk layer to required surface treatment, characterized in that the bulk layer is fabricated by electrolysis of a copper electrolyte containing one kind or two or more kinds selected from glue, gelatin and collagen peptide in an amount of 30 ppm to 1,000 ppm.

8. A method of manufacturing carrier foil-incorporated copper foil according to any one of claims 4 to 6 claim 4, which involves forming an adhesive interface layer on a surface of the carrier foil, subjecting the bulk copper layer to nodular treatment and further subjecting the bulk layer to required surface treatment, characterized in that a high-carbon copper layer with a thickness of 0.1 μm to 5 μm is formed by the electrolysis method by use of a copper electrolyte containing one kind or two or more kinds selected from glue, gelatin and collagen peptide in an amount of 100 ppm to 1,000 ppm and a pure copper layer is formed on the high-carbon copper layer by electrolysis of the copper electrolyte.

9. A copper-clad laminate obtained by using the carrier foil-incorporated copper foil in which the bulk copper layer is formed from high-carbon copper according to any one of claims 1 to 3 claim 1.

10. A copper-clad laminate obtained by using the carrier foil-incorporated copper foil in which the bulk copper layer is formed from high-carbon copper and pure copper layer according to any one of claims 4 to 6 claim 4.
